(19) United States
(12) Patent Application Publication
(10) Pub. No.: US 2006/0170537 A1
(43) Pub. Date: Aug. 3, 2006

(54) Intrusion detector

(76) Inventor: Paul Marriott, Worcestershire (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 10/520,317

(22) PCT Filed: Jul. 4, 2003
(86) PCT No.: PCT/GB03/02892

§ 371 Date: Jul. 15, 2005

(30) Foreign Application Priority Data
Jul. 5, 2002 (GB) 0215611.5
Mar. 17, 2003 (GB) 0306033.2

(51) Int. Cl. B60R 25/10

(52) U.S. Cl. 340/426.24

(57) ABSTRACT

An intrusion detector for a vehicle, such as the trailer of a tractor-trailer combination. The detector, which is attachable to the vehicle, includes a carbon dioxide detector responsive to the concentration of carbon dioxide in a compartment of the vehicle. The intrusion detector generates an alarm if the carbon dioxide concentration in the compartment exceeds a predetermined level.

### DESCRIPTION OF INVENTION

This invention relates to an intrusion detector for a vehicle, particularly but not exclusively to an intrusion detector for a vehicle comprising a trailer for a tractor trailer combination, and also to a vehicle comprising an intrusion detector.

When a vehicle is adapted to transport goods, it is desirable that the vehicle be secured against unauthorised entry, whether for the purposes of theft for concealing a person therein, or otherwise. It is known to seal vehicle doors, such that it is apparent if the doors have been opened, but it requires periodic inspection of the seal to check that it is intact, and where it is desirable for a vehicle to be repeatedly opened, for example for inspection or loading such a seal may not be appropriate. It is also known to use hand held carbon dioxide probes to check a compartment of the vehicle for the presence of carbon dioxide from human respiration, but again such checks may only be made at widely separated intervals, and only on a small proportion of all possible vehicles, for example of vehicles passing through a customs post.

An aim of the invention is to provide a new or improved intrusion detector for a vehicle.

According to a first aspect of the invention, we provide an intrusion detector for a vehicle, the detector being attachable to the vehicle, wherein the intrusion detector comprises a carbon dioxide detector responsive to the presence of carbon dioxide in a compartment of the vehicle, and wherein the intrusion detector is operable to generate an alarm if the proportion of carbon dioxide in the compartment exceeds a selected level.

The vehicle may comprises a trailer for a tractor-trailer combination.

The intrusion detector may be adaptable to be mounted on the vehicle and wherein may be duct is provided whereby air from the compartment may be passed to the carbon dioxide detector.

The intrusion detector may comprise a fan to pass air from the compartment to the carbon dioxide detector.

The intrusion detector may be connectable to a power supply of the vehicle and may further comprise a battery which may be charged by the power supply.

The selected level of carbon dioxide may be at least 2500 ppm, and preferably at least 3500 ppm, and most preferably at least 2000 ppm.

The alarm may comprise at least one of an audible alarm, a visual alarm, and the transmission of an alarm message.

The intrusion detector may comprise an auxiliary detector responsive to the presence of a person in the component.

The auxiliary detector may be a PIR detector on a microwave detector.

According to a second aspect of the invention, we provide a vehicle comprising an intrusion detector.

The vehicle may comprise a trailer and the intrusion detector may be mounted on a outer surface of the vehicle.

Where the intrusion detector comprises an auxiliary detector the auxiliary detector may be located in the compartment.

An embodiment of the invention will now be described by way of example only with reference to the accompanying drawings wherein;

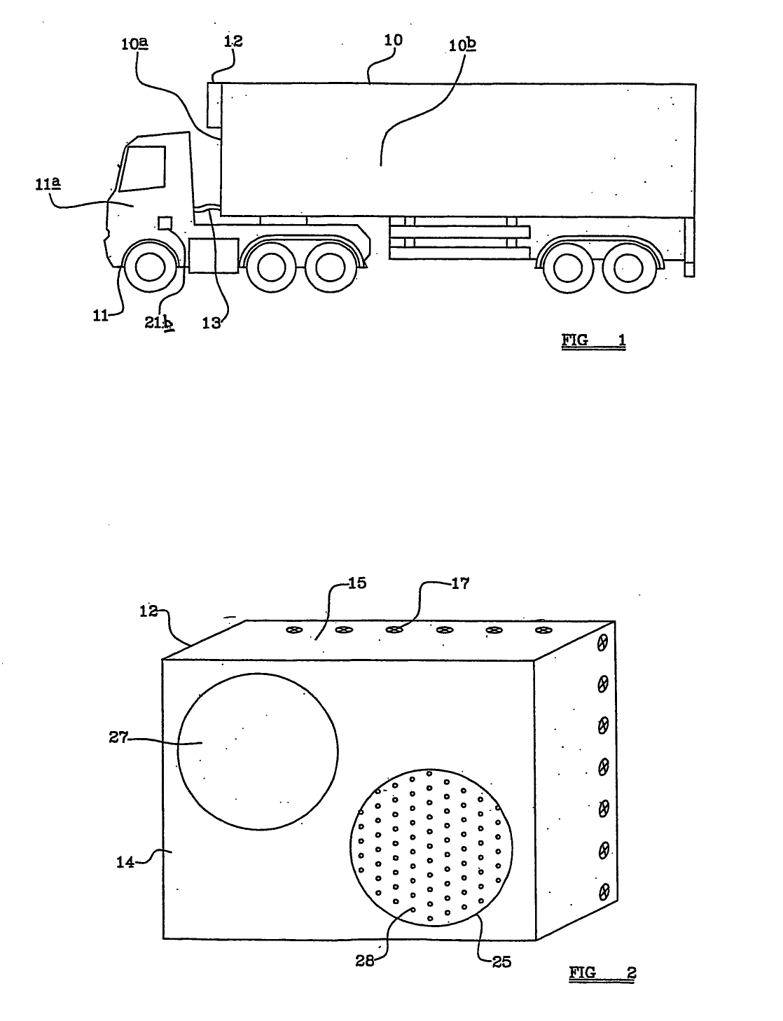

FIG. 1 is a diagrammatic illustration of a vehicle provided with an intrusion detector embodying the present invention,

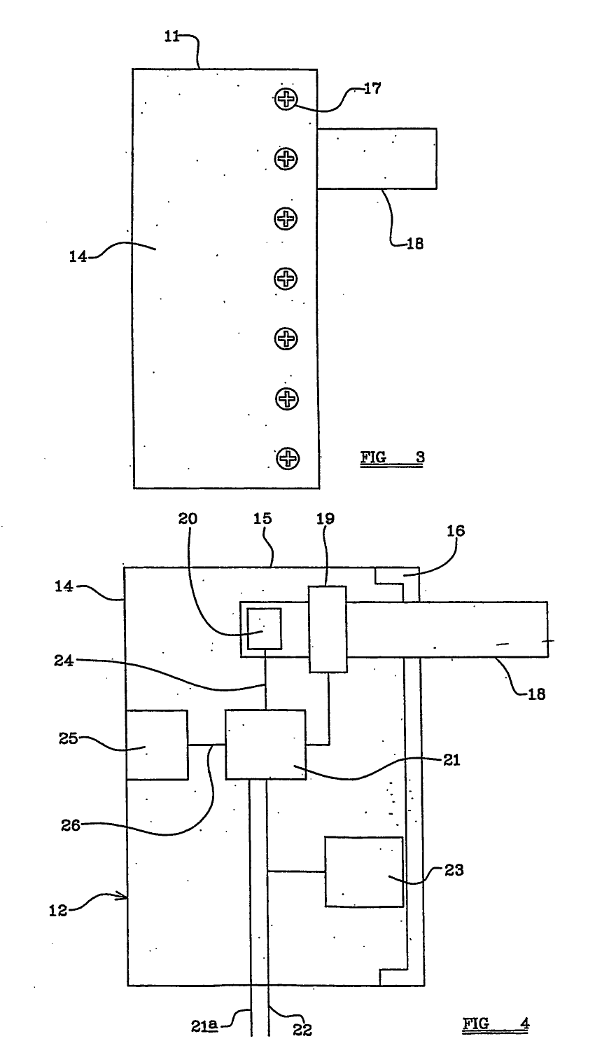

FIG. 2 is a perspective view of an intrusion detector embodying the present invention,

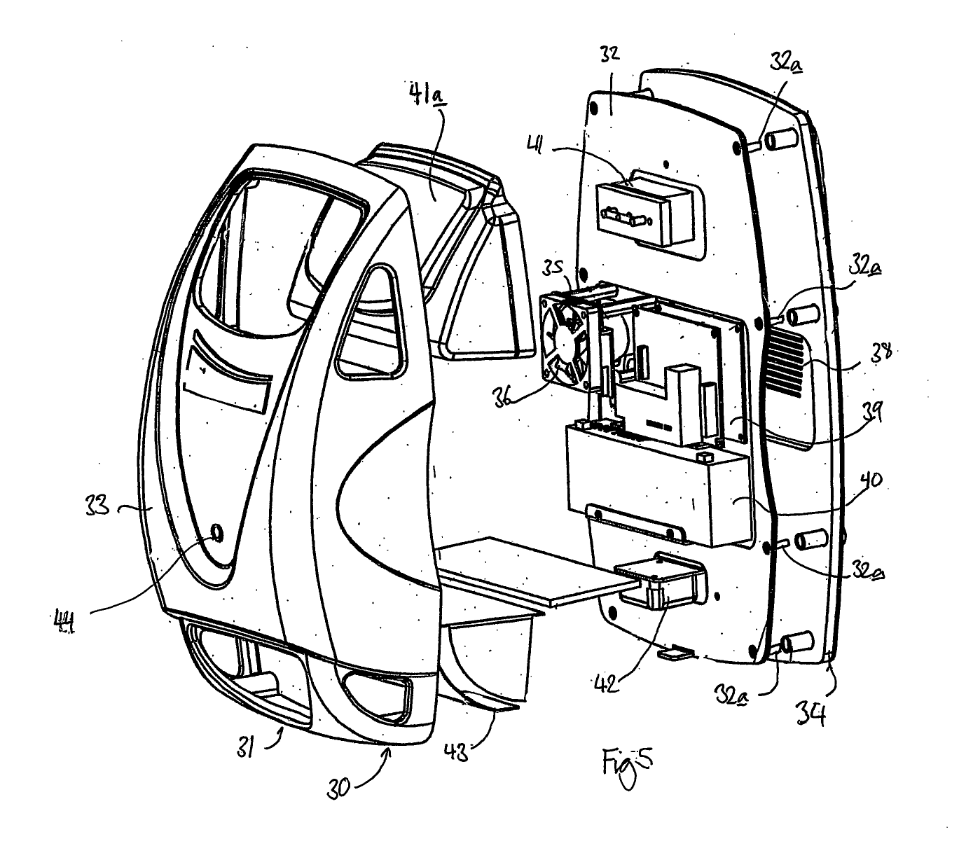

FIG. 3 is a side view if the intrusion detector of FIG. 2,

FIG. 4 is a diagrammatic illustration of the intrusion detector of FIG. 2,

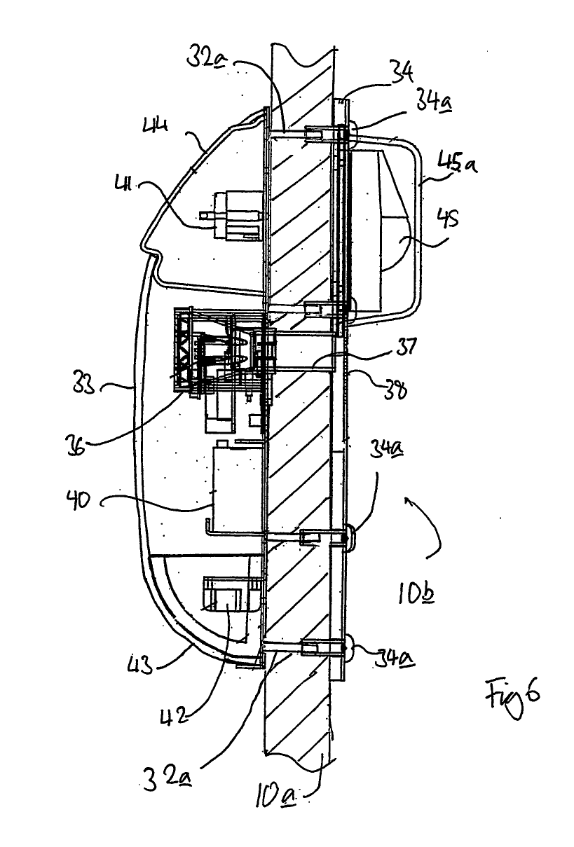

FIG. 5 is an exploded perspective view of a further intrusion detector embodying the present invention,

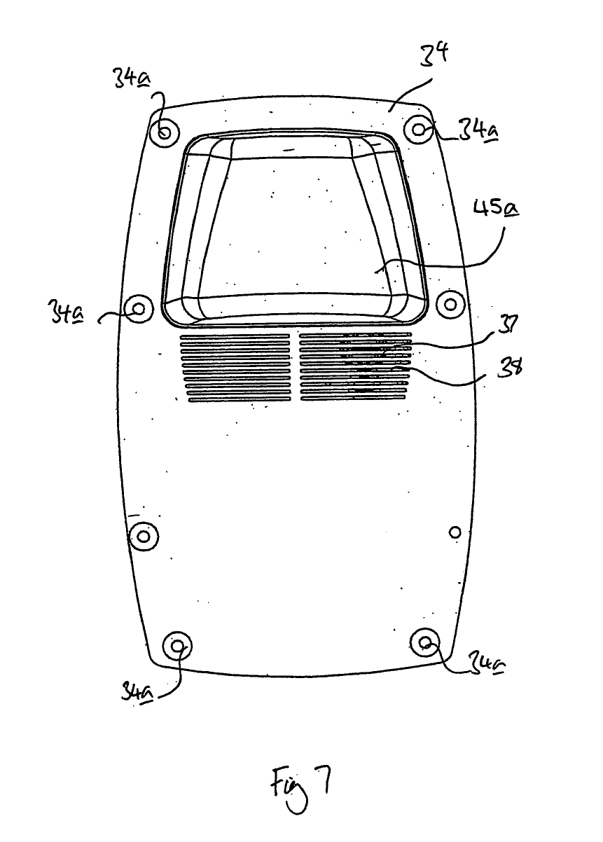

FIG. 6 is a section through the intrusion detector of FIG. 5 when installed on a vehicle bulk head, and,

FIG. 7 is an end view of part of the intrusion detector of FIG. 5.

Referring now to FIG. 1, a vehicle is shown comprising a trailer 10. In this example, the trailer is conventional and intended to be drawn by a tractor 11 having a cab 11a. The trailer 10 is provided with an intrusion detector 12 embodying the present invention. In this example, the intrusion detector 12 is mounted externally of the trailer 10 at a position located towards the top of a forward wall 10a of the trailer 10. As seen in FIG. 1, the trailer 10 and tractor 11 are connected in conventional manner by conventional electrical and pneumatic connections 13 as shown, and the intrusion detector 12 may be connected to an appropriate supply of power from the tractor 11. The trailer 10 comprises a compartment 10b, comprising a closed volume in which goods may be carried.

Referring now to FIGS. 2 to 4, the intrusion detector 12 comprises a case 14 which is resistant to attempt to remove or damage the intrusion detector 12. In the present example, the case 14 comprises a cover 15 comprising stainless steal attached to a galvanised steal chassis 16. The cover 15 is attached to the chassis 16 by suitable tamper resistant fixings 17, in the present example tamper resistant screws. The case 14 is preferably weather proof. A tamper switch may be provided connected to the cover 15 to cause the alarm 25 to be activated when the cover 15 is removed.

The intrusion detector 12 comprises a duct 18 which extends into the interior of the compartment where intrusion detection is required, in the present example into the compartment 10b of the trailer 10. In the present example, the intrusion detector is further provided with a fan 19 which draws air in through the duct 18 and passes the air over a carbon dioxide detector 20. The intrusion detector 12 comprises a suitable electronic controller 21 which is powered by a power connection 22 and/or by a suitable auxiliary power source, in the present example a battery 23. The controller 21 is connected by a line 24 to the carbon dioxide detector 20 to receive a signal dependent on the proportion of carbon dioxide in the air drawn in through the duct 18. The auxiliary power means 23 may comprise, in addition to or in place of the battery, other means such as a solar panel to generate power. The controller 21 may be operable to deactivate itself if the power available in the auxiliary power means has dropped below a particular level.

To allow for actuation and deactivation of the device, the controller 21 is provided with a control connection 21a. The control connection 21a may transmit activation and deactivation signals to the controller 21, for example from a control system 21b in the cab 11a of the tractor 11. The controller may also transmit information on the control connection 21a, such as power level information, alarm status information or any other information as desired. The control connection 21a may instead comprise a wireless connection, such as a radio or infra-red connection.

The intrusion detector 12 is further provided with a suitable alarm, generally indicated at 25 and connected to the controller 21 by line 26. In this example, the alarm means 25 comprises an externally visible strobe light 27 and an audible siren 28, mounted internally within the case 14. Alternatively, or additionally, the intrusion detector 12 may be operable to transmit a message by any appropriate means to a suitable recipient alerting them to the intrusion. For example, a message may be transmitted by radio or by cellular radio telephone or by other means as desired to the police or to a vehicle control centre or to a personal communication device carried by the driver or otherwise. Where the intrusion detector 12 is provided with a wireless connection, either in place of the control connection 21a or as part of means of transmitting an alarm, status information may be made available where desired, for example to customs officials or other inspectors as desired.

In operation, when it is desired to protect the vehicle 10 against unauthorised intrusion, the intrusion detector 12 is activated. If the trailer 10 is connected to the tractor 11 and power is being supplied from the tractor 11 to the trailer 10, the intrusion detector 12 may draw power from the power connection 22, otherwise the intrusion detector will be powered from the auxiliary power source 23. Air from the compartment 10b is drawn in through the duct 18 by the fan 19 and passed over the carbon dioxide generator 20. To conserve power, it will be apparent that the fan 19 need not be operated continuously, but that the air in the compartment 10b may be tested at intervals, for example every 15 minutes and the fan 19 operated for the period of time necessary to take a sample. Alternatively, it may be possible to omit the fan 19 by mounting the carbon dioxide detector 20 such that sufficient air from the compartment can be measured by the detector 20 without being actively drawn through the duct 18. The carbon dioxide detector 20 is responsive to the proportion of carbon dioxide in the air in the compartment 10b and is operable to generate an appropriate signal on line 24 to the controller 21. When the proportion of carbon dioxide in the chamber 10b exceeds a pre-selected level, in the present example at least 2500 ppm and in practise at least 2000 ppm and more preferably at least 3500 ppm, this will be deemed to be evidence of a person entering the compartment 10b and causing the level of carbon dioxide to rise by virtue of respiration of that person within the compartment 10b. On detecting the intrusion, the controller 21 will activate the alarm 25, providing a visual and/or an audible warning and/or generating an alarm message as discussed above. The controller 21 will preferably “latch” so the alarm will continue to sound even if the carbon dioxide proportion in the compartment 10b falls below the selected level, and the case 14 is preferably sufficiently sturdy to avoid concerted physical attack or tampering to silence or otherwise interrupt the alarm 25.

When it is desired to legitimately enter the compartment 10b, the intrusion detector 12 may be deactivated.

In the present example, it is intended that the intrusion detector 12 will in a default state be active. Preferably, the intrusion detector 12 is operable to become active when the ignition on the tractor 11 is operated even if the intrusion detector 12 has not been properly reactivated. To permit legitimate entry to the compartment 10b, for loading or inspection purposes, the intrusion detector 12 is deactivated by the driver by following a series of actions using the ignition, directional indicators and stop lights in the cab 11a. The timing and pattern of the actions will be monitored by control system 21b which may be a micro-processor, for example by algorithmic integration. It will be apparent that the control system 21b may then send a signal on the control connection 21a to active or deactivate the intrusion detector 12, or may send details of the actions performed on connection 21a to the controller 21, which may then decide to activate or deactivate the intrusion detector 12 itself on the basis of the received information.

A similar process of actions performed by the driver may be used to active the intrusion detector 12. Alternatively, it may be envisaged that the intrusion detector 12 will return to its active state after a set time period has elapsed unless the deactivation actions are performed again.

When it is desired to uncouple the trailer 10 from the tractor 11, a similar series of actions may be performed. By performing the appropriate series of actions, the driver may leave the intrusion device on the trailer in an activated or deactivated state as appropriate. It might be envisaged that if the tractor 11 and trailer 10 are separated without appropriate actions being performed, the controller 21 may detect the loss of signal on the control line 21a and may activate the alarm, for example as a response to what made an attempted theft of the tractor 10 or trailer 11.

The carbon dioxide detector 20 and controller 21 can be implemented as desired. For example, the carbon dioxide detector 20 may send a signal comprising a voltage which is proportional to the proportion of carbon dioxide detected in the air from the compartment 10b and the controller 21 may activate the alarm 25 when that voltage passes a level set on the controller 21. Alternatively, the carbon dioxide detector 20 may be operable to pass a signal to the controller 21 only when the proportion of carbon dioxide in the air of the compartment 10b exceeds a pre-selected level set on the carbon dioxide detector 20 and the controller 21 may activate the alarm 25 in response to that signal. The proportion of carbon dioxide at which the alarm is activated may be set at the factory, or adjustment means, for example a variable resistor or other appropriate means may be provided on the carbon dioxide detector 20 and/or controller 21. The proportion of carbon dioxide at which the alarm is activated should be selected in view of the normal conditions within the compartment 10b to avoid a false alarm, that is triggering the alarm when no intruder is present, but to ensure that the alarm is activated by the presence of an intruder without undue delay.

A further embodiment of an intrusion detector embodying the present invention will now be described with reference to FIGS. 5 to 7. An intrusion detector is generally indicated at 30 which comprises an outer part 31 having a back plate 32 which is attached to the external surface of a forward wall 10a of a trailer 10 and a cover 33. A second part 34 of the instruction detector 30 is attached to the interior surface of the forward wall 10a of the trailer as best seen in FIG. 6.

Mounted on the back plate 32 of the first part 31 is a sensor and fan assembly 35 including a fan 36. The fan 36 is operable to draw air through an air intake tube 37 which passes through the forward wall 10a and into the compartment 10b of the trailer 10. As seen in FIG. 7 the second part 34 comprises a grille 38 to cover the end of the air intake tube 37. An electronic controller 39 is provided powered by a battery 40 connected to the sensor in the sensor assembly 35 and is operable in like manner to the electronic controller 21 of the embodiment of FIGS. 2 to 4. To provide an alarm, the intrusion detector 30 has a strobe light 41 and a sounder 42 to generate visual and audible alarms. A grille at 43 in the external casing is located in front of the sounder 42, while an appropriate transparent or translucent lens 44 is provided in the cover 33 to be located over the strobe 41.

The intrusion detector 30 further comprises an auxiliary detector as shown at 45 in FIGS. 6 and 7. The auxiliary detector 45 is an appropriate detector responsive to the presence of a person in the field of view of the detector, such as a PIR detector or microwave detector. The auxiliary detector 45 is connected to the electronic controller 39 such that the electronic controller 39 is operable to activate an alarm in response to the detector 45 detecting the presence of a person and/or the sensor in the sensor assembly 35 detecting an increase in the level of carbon dioxide in the compartment 10b as in the embodiment hereinbefore described.

The second part 34 is connected to the wall 10a by appropriate shear bolts 34a to hinder removal of the second part 34. The first part 31 is provided with an appropriate detector to detect when the cover 33 is removed, for example by providing a micro switch on the back plate 32 located to engage the cover 33 when the cover is in place, and connected to the electronic controller 39 such that the electronic controller 39 may activate an alarm in response to the cover 33 being removed.

In both embodiments of intrusion detectors described hereinbefore, a connection is provided from the intrusion detector 12, 30 to the wiring loom (not shown) of the trailer 10 so that the electronic controller 12, 39 can detect the operation of the brake lights, indicators, ignition and other operation as required to activate or deactivate the intrusion detector 12, 30.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An intrusion detector for a vehicle, the detector being attachable to the vehicle, wherein the intrusion detector comprises a carbon dioxide detector responsive to the presence of carbon dioxide in a compartment of the vehicle, and wherein the intrusion detector is operable to generate an alarm if the concentration of carbon dioxide in the compartment exceeds a selected level.

2. (canceled)

3. An intrusion detector according to claim 1 wherein the intrusion detector is adapted to be mounted on the exterior of the vehicle and wherein a duct is provided whereby air from the compartment may be passed to the carbon dioxide detector.

4. An intrusion detector according to claim 3 and further including a fan adapted to pass air from the compartment to the carbon dioxide detector.

5. An intrusion detector according to claim 1, and wherein said detector includes a battery which is connectable to be charged from a power supply of the vehicle.

6. An intrusion detector according to claim 1, and wherein said selected level of carbon dioxide is at least 2000 ppm.

7. An intrusion detector according to claim 1, and wherein the alarm includes at least one of an audible alarm, a visual alarm, and the transmission of an alarm message.

8. An intrusion detector according to claim 1, and further including an auxiliary detector responsive to the presence of a person to the compartment.

9. An intrusion detector according to claim 8, and wherein the auxiliary detector comprises a PIR detector.

10. (canceled)

11. (canceled)

12. (canceled)

13. (canceled)

14. (canceled)

15. (canceled)

16. An intrusion detector according to claim 8, and wherein the auxiliary detector comprises a microwave detector.

17. An intrusion detector according to claim 6, and wherein said selected level of carbon dioxide is at least 2500 ppm.

18. An intrusion detector according to claim 6, and wherein said selected level of carbon dioxide is at least 3500 ppm.

19. In combination with a vehicle having a compartment, an intrusion detector attached to said vehicle, said intrusion detector including a carbon dioxide detector responsive to a predetermined concentration of carbon dioxide in said compartment for generating an alarm.

20. A vehicle with an intrusion detector, according to claim 19, and wherein said vehicle comprises a trailer for a tractor-trailer combination.

21. A vehicle with an intrusion detector, according to claim 19, wherein said intrusion detector is mounted on an exterior of said vehicle, and wherein said intrusion detector is connected through a duct to said compartment.

22. A vehicle with an intrusion detector, according to claim 21, and wherein said intrusion detector further includes a fan mounted to cause a flow of air from said compartment through said carbon dioxide detector.

23. A vehicle with an intrusion detector, according to claim 21, and wherein said predetermined carbon dioxide concentration is at least 2000 ppm.

24. A vehicle with an intrusion detector, according to claim 22, and wherein said predetermined carbon dioxide concentration is at least 2500 ppm.

25. A vehicle with an intrusion detector, according to claim 22, and wherein said predetermined carbon dioxide concentration is at least 3500 ppm.
